(19) United States
(12) Patent Application Publication
(10) Pub. No.: US 2015/0253847 A1
(43) Pub. Date: Sep. 10, 2015

(54) WEARABLE DEVICE CONTROLLER

(71) Applicant: EASIER TO USE, LLC, PLAINVILLE, MA (US)

(72) Inventors: Benjamin G. Harris, Plainville, MA (US); Michael Conti, Arlington, VA (US); Eric J. Ely, Goffstown, NH (US)

(21) Appl. No.: 14/638,670

(22) Filed: Mar. 4, 2015

Related U.S. Application Data
(60) Provisional application No. 61/949,394, filed on Mar. 7, 2014.

(51) Int. Cl. G06F 3/01

(52) U.S. Cl. CPC G06F 3/014; G06F 3/017

(57) ABSTRACT

A method for capturing finger motions and interpreting the captured finger motions into commands for a mobile computing device can comprise receiving, from a first finger mounted sensor, a first sensed finger position of a first finger relative to a second finger. The method can also comprise converting, with a processing unit, the first sensed finger position to a data packet communicable to the mobile computing device. Further, the method can comprise transmitting the data packet to the mobile computing device, wherein the data packet causes the mobile computing device to execute a command.

### CROSS-REFERENCE TO RELATED APPLICATIONS

This application claims priority to and the benefit of U.S. Provisional Application No. 61/949,394, filed on Mar. 7, 2014, entitled “Wearable Device Controller,” which is incorporated by reference herein in its entirety.

### BACKGROUND OF THE INVENTION

1. Technical Field

The present invention relates to a wearable device controlling an electronic device.

2. Background and Relevant Art

Mobile devices, such as smartphones, mp3 players, cameras, tablets, and e-Readers, have become ubiquitous in recent years, but to control them still requires interaction directly with their screen or buttons. Simple tasks such as answering a phone call, pausing a song, or activating voice control are difficult if the user cannot easily w reach their device. At times, there are urgent moments when you need to interact with your mobile device but it's in a pocket or a purse and cannot be easily accessed. During outdoor activities or when you have on gloves it is even more difficult to interact with your mobile device. These tend to be common times when devices get dropped and broken.

Accordingly, there is a need in the art for improved systems, methods, and apparatuses for interacting with mobile devices.

### BRIEF SUMMARY OF THE INVENTION

Implementations of the present invention comprise systems, methods, and apparatus configured to provide novel and natural methods for interacting with mobile devices. In particular, implementations of the present invention comprise a control module that is configured to receive commands from sensors within a glove andor commands from direct user interaction with the control module. Accordingly, implementations of the present invention provide a user with the ability to control a mobile device with simple hand motions or to control the device through physical interaction with the control module.

At least one implementation of the present invention can comprise a method for capturing finger motions and interpreting the captured finger motions into commands for a mobile computing device. Specifically, the method can comprise receiving, from a first finger mounted sensor, a first sensed finger position of a first finger relative to a second finger. The method can also comprise converting, with a processing unit, the first sensed finger position to a data packet communicable to the mobile computing device. Further, the method can comprise transmitting the data packet to the mobile computing device, wherein the data packet causes the mobile computing device to execute a command.

An additional implementation of the present invention can comprise a motion capture command system for capturing finger motions directed towards controlling a mobile computer device. The system can comprise a form fitting glove that includes at least an enclosed finger sheath and an enclosed thumb sheath. The thumb sheath can comprise an embedded thumb sensor unit. Similarly, the finger sheath can also comprise an embedded finger sensor unit. The system can further comprise a processing unit in communication with at least one of the embedded thumb sensor unit or the embedded finger sensor unit. The processing unit can be configured to detect a relative position of the embedded finger sensor unit with respect to the embedded thumb sensor unit. As used within this specification and the appended claims, the word “finger” means any of the digits of the hand, including the pinkie finger, ring finger, middle finger, index finger, andor thumb.

Additionally, in at least one embodiment, a “sensor unit” may comprise a portion of a sensor or a non-active detectable component. For example, a sensor unit may comprise a magnet that is detectable by at least one other sensor unit. As such, an individual sensor unit is not required to be able to detect anything, but instead may be instead be detectable by another sensing unit.

Further, at least one implementation of the present invention can comprise a device control module for receiving detected finger motions and providing commands to a mobile computing device. The device control module can comprise a sensor input port that is configured to communicate with one or more sensors that are disposed within a glove. The sensor input port can comprise a connector that can be connected to and disconnected from the one or more sensors. Additionally, the device control module can comprise at least one button positioned on a face of the device that is configured to be actuated by a user. The device control module can be configured to communicate one or more commands to the mobile computing device.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above recited and other advantages and features of the invention can be obtained, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a system of user input device and mobile devices in accordance with implementations of the present invention;

FIG. 2A illustrates a perspective view of a control module in accordance with implementations of the present invention;

FIG. 2B illustrates a side view of a control module in accordance with implementations of the present invention;

FIG. 3 illustrates a view of a control module in wired communication with various embedded sensors in accordance with implementations of the present invention;

FIG. 4 illustrates a view of a two embedded sensors in communication with each other in accordance with implementations of the present invention;

FIG. 5 illustrates a user interface for customizing sensor readings to commands in accordance with implementations of the present invention; and

FIG. 6 illustrates a flow chart of a method for capturing finger motions and interpreting the captured finger motions into commands for a mobile computing device in accordance with implementations of the present invention.

### DETAILED DESCRIPTION OF THE PREFERRED EMBODIMENTS

The present invention extends to systems, methods, and apparatus configured to provide novel and natural methods for interacting with mobile devices. In particular, implementations of the present invention comprise a control module that is configured to receive commands from sensors within a glove andor commands from direct user interaction with the control module. Accordingly, implementations of the present invention provide a user with the ability to control a mobile device with simple hand motions or to control the device through physical interaction with the control module

The rapid proliferation of smart phones, tablets, and other mobile computing devices has created a large market for accessories and content. In particular, individuals spend significant amounts of money purchasing media, apps, and accessories for their mobile devices. Additionally, individuals integrate use of their mobile devices into their daily lives and activities.

The use of and interaction with mobile devices has become common through nearly every sport activity and leisure activity. For instance, it is common for runners to run while listening to music from a mobile phone or for skiers to while listening to music on a mobile computing device. As the use of mobile devices during activities has increased, the need to easily be able to control these devices has grown.

While many mobile devices comprise touch screen interfaces, these interfaces can be difficult for an individual to control and interact with during an activity. For example, it may be difficult for an individual who is skiing to control a mobile device using conventional methods and systems if for no other reason than the difficulty of answering a phone call while physically skiing down a slope. Similarly, an individual may enjoy biking. A touchscreen interface, however, may be too complex andor too distracting to effectively use while biking.

As an additional example, an individual may work within a warehouse where temperatures are low. As such, the individual may wear gloves during work. At least one embodiments of the present invention can allow the individual to control a mobile device while working without having to directly access the mobile device. This may particularly useful in minimizing the risk that the individual will drop or otherwise damage their mobile device.

As such, implementations of the present invention provide novel solutions to user interactions with mobile devices. In particular, implementations of the present invention provide methods, systems, and apparatuses for naturally and easily interacting with mobile devices while performing various sports and activities. For example, implementations of the present invention provide methods, systems, and apparatuses for interacting with a mobile computing device while wearing gloves and without having to physically interact with the device itself. Additionally, implementations of the present invention provide a user interface scheme that is highly adaptable to the needs and desires of a user.

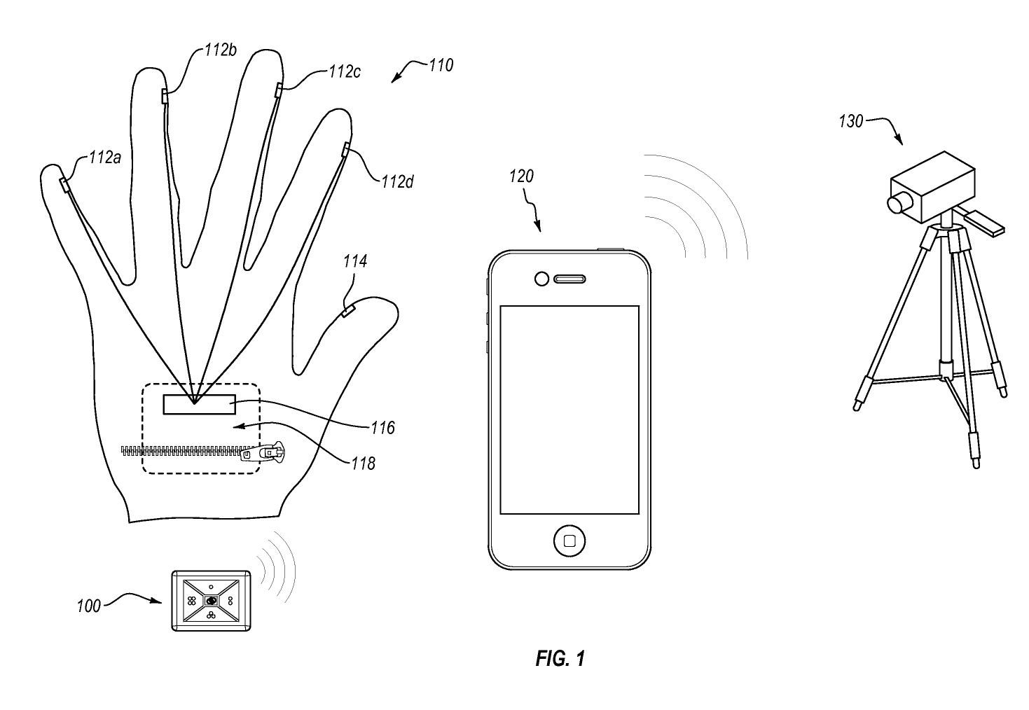

For example, FIG. 1 depicts a collection of devices in accordance with an implementation of the present invention. Specifically, FIG. 1 depicts a control module 100, a glove 110, a mobile computing device 120, and an external electronic device 130 (in this case a digital camera). In at least one implementation, the control module 100 can be in wired or wireless communication with the mobile computing device 120. Additionally, the mobile computing device andor the control module 100 can be in wired or wireless communication with the external electronic device 130. The control module 100 can comprise a processing unit capable of receiving sensor readings and preparing the sensor readings to communication to the mobile computing device 120.

In at least one implementation, the control module 100 can be used to send commands to the mobile computing device 120 andor the external electronic device 130. The control module 100 can be used with the glove 110 to send commands or independently as a standalone device. In at least one implementation, the control module 100 can communicate a command to the mobile computing device 120 that can then forward commands to the external electronic device 130.

As depicted, the glove 110 may comprise a pouch. The pouch 118 may be positioned on the back of the hand, within the cuff of the glove, or in some other position. The pouch may be configured to receive the control module 100. The pouch may comprise a zipper, a Velcro enclosure, or some other means for enclosing the control module within the glove 110. The pouch may also comprise a waterproof or water resistant material such that the control module 100 is protected from moisture.

In contrast, in at least one implementation, the control module 100 is attachable to the glove 110, but the control module 100 is not enclosed by the glove. For example, the control module 100 may comprise a clasp that is configured to attach to a slit in the fabric of the glove 110. As such, in at least one implementation, the control module 100 individually can comprise water proof or water resistant construction.

In at least one implementation, the left and right gloves can be constructed predominantly of a single layer of c24 polyester spandex material. This single layer of material can be expanded upon such that top portion of the right hand glove andor the top portion of the left hand glove comprise additional layers of fabric. For example, the top portion of one or both of the gloves may comprise a double layer of fabric to hide the electronics. The inner layer of fabric may comprise a 60g polyester type fabric. In at least one implementation, it may be desirable for the inner layer of fabric to be lighter and thinner than the outer layer. Further, in at least one implementation, the top portion of the glove may comprise three layers of fabric to further divide the electronics. In at least one implementation, however, only the right glove or only the left glove may comprise the pouch 118, embedded sensors 112(a-d), 114), and multiple wires. One will understand, however, that the materials disclosed herein are merely exemplary and are not meant to limit the materials that can be incorporated within the invention.

Additionally, one or more of the fingertips of the gloves may also comprise conductive threads that allow a user to interact with a capacitive touch screen. In particular, the index finger and the thumb may comprise the capacitive threads or conductive patch. As such, in at least one implementation, a user can interact with a mobile computing device 120 using both finger motions, buttons on the control module, and through interacting with a capacitive touch screen on the mobile computing device 120.

Additionally, in at least one implementation, the glove 110 may comprise a connector 116. The connector may be compatible with a connector associated with the control module 100. As such, the control module 100 can be electronically connected to the glove 110. In at least one implementation, the connector on the control module 110 can also be configured for use as a charging port for recharging batteries within the control module 100.

In at least one implementation, the control module 100 can comprise a second port (not shown) that allows the control module 100 to be in communication with the connector 116 within the glove 110 and with a connector to a mobile computing device 120. The second connector may also provide a charging feature that allows the control module 100 to charge from the second port. Further, the second port may be configured to receive power directly from the power supply of the mobile computing device 120, such that in at least one implementation, the control module 100 does not comprise an internal battery.

The second port may also comprise a standard stereo jack. The control module 100 may be able to communicate through the stereo jack to the mobile computing unit 120. For example, in at least one implementation, the mobile computing unit 120 may comprise a smart phone. Many modern smart phones are configured to receive commands through a stereo jack. Common commands may include play, stop, pause, volume up, volume down, skip, and other similar commands. In at least one implementation, however, these commands can be expanded to include any function that the mobile computing device 120 is capable of performing

In at least one implementation, the glove 110 may comprise various embedded sensors 112(a-d), 114. The embedded sensors 112(a-d), 114 may be capable of detecting finger motion, finger position, or other finger and hand motions or positions. For example, embedded sensors 112(a-d) may comprise magnetic or electromagnetic sensor, either mechanical (e.g. a reed switch) or solid state (e.g. a hall effect sensor), while embedded sensor 114 may comprise a magnet. As such, as a user draws embedded sensor 112(a-d) close to the magnet 114, the electromagnetic sensor may activate.

The embedded sensors 112(a-d), 114 may also comprise a concave inner surface that is nearest to a user's fingers. As such, the embedded sensors 112(a-d) may be shaped to conform to the shape of a user's fingers. Additionally, in at least one implementation, the embedded sensors 112(a-d), 114 may comprise flexible components such that the sensors flexibly conform to a user's fingers. In various implementations, the embedded sensors 112(a-d), 114 may comprise dimensions of 7 mm×2 mm×1mm. Additionally, in at least one implementation, the sensors are stitched, glued, or otherwise attached to the gloves. In particular, the sensors may be connected to the gloves such that the sensors do not shift or move.

In contrast, in at least one implementation, the embedded sensors 112(a-d), 114 may comprise inertia sensors, such as gyroscopes, accelerometers, and other related sensors. In such a case, the sensors can detect finger or hand motion. One will understand, that a variety of different types and configurations of sensors can be embedded within the glove 110. The sensors may be uniformly spread across the fingers and thumb, or configured such that one or more of the fingers and thumb have different sensors. Accordingly, in at least one implementation, a user can control a mobile computing device 120 through finger motions that are communicated through the glove 110 to the control module 100.

While the present description is directed towards a glove embodiment, in at least one implementation, instead of a glove, a wrist band can comprise embedded sensors 112(a-d), 114. Using the methods and systems described herein, the wrist band can be interacted with such that the sensors actuate and communicate commands to the mobile computing device 120. In the least one implementation, the wrist band can comprise electromagnetic sensors, either mechanical or solid state, 112(a-d) that are actuated by a magnetic ring 114. For example, a user can bring the magnetic ring 114 within proximity to a specific portion of the wrist band. This proximity can cause a electromagnetic sensor 112(a-d) to activate and send a command to the mobile computing device 120. Additionally, in at least one implementation, one or more sensors can be embedded within a palm of the glove 110. As such, communication may occur between sensors embedded within the finger sheaths and sensors embedded within a palm of the glove.

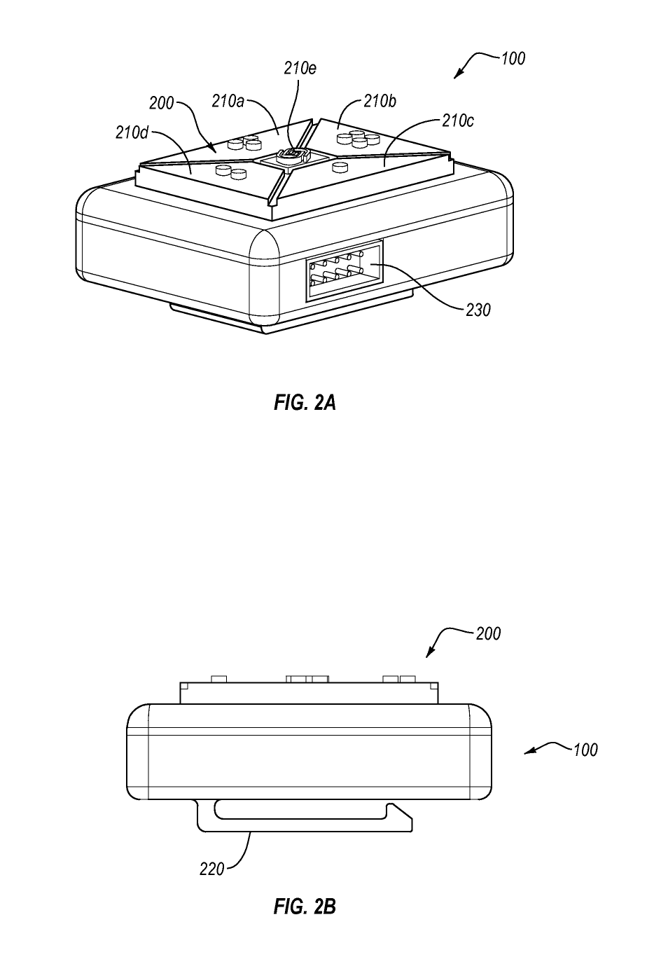

FIGS. 2A and 2B depict different perspectives of an implementation of a control module 100. In at least one implementation, the control module can comprise both a communication port 230 and one or more buttons 200. The control module 100 can comprise the same number of buttons 210(a-e) as there are embedded sensors 112(a-d), 114 within the glove 110. In particular, in at least one implementation, every command that can be initiated using the glove 110 can also be initiated using the buttons 200.

For example, using the glove 110 of FIG. 1, a user can bring his or her index finger close to his or her thumb. In at least one implementation, this motion can cause a electromagnetic sensor 112D to activate when placed within sufficient proximity to a magnet 114. Instead of using finger motions, a user may be to execute the same command by pressing button 210D.

Further, in at least one implementation, different commands can be actuated based upon a duration of the command, a sequence of commands, or other such command combinations. For example, bringing embedded sensor 112D close to embedded sensor 114 for an extended period of time may comprise a different command then bringing the sensors 112D, 114 within proximity of each other for a short period of time.

Additionally, each sensor may be associated with specific commands. For instance, bringing the index finger sensor 112d near the thumb sensor 114 may issue a play command. In contrast, bringing the middle finger sensor 112c near the thumb sensor 114 may issue a skip track command. Further, in at least one implementation, bringing the pinkie finger sensor 112a near the thumb sensor 114 may put the control module 100 into a sleep mode such that new commands are not received until the pinkie sensor 112a is again brought near the thumb sensor 114. These specific commands can include single and double tap functionality to enable the user to have more than 4 functions available.

Similar differences in commands can be created using the buttons 200 by pressing a button 112D for an extended period of time or for a short period of time. In particular, assigning each button 210(a-e) to a particular sensor 112(a-e) can allow a user to replicate the sensor commands with the respective buttons. Accordingly, one will understand that similar commands can be created within both the glove 110 and the buttons 200 by replicating duration of commands, sequence of commands, or other command combinations.

Additionally, in at least one implementation, the control module 100 can be used independent of the glove 110. For example, the control module 100 can be attached to a bike frame such that the biker can control their mobile computing device 120 by simply pressing the buttons 210(a-e) on the control unit. Accordingly, implementations of the present invention provide unique and diverse systems and methods for controlling a mobile computing unit 120.

For example, implementations of the control module 100 allow a user to control a mobile computing device with simple finger motions andor with simple presses of a button. One will understand significant benefits created by allowing a user to control a mobile computing unit 100 through finger motions. For example, while skiing and wearing gloves a user, using implementations of the present invention, can easily skip songs, change volumes, stop music, answer phone calls, send texts, or perform any number variety of different mobile computing device functions.

Additionally, one will understand, the benefits of providing a control module 100 that can also send commands to a mobile computing device 120 without a glove 110. For example, an individual who enjoys skiing may also enjoy biking. As described above, a standalone control module 100 provides a novel interface for controlling a mobile computing unit while riding a bike. In particular, one will understand that wearing a full-fingered glove for bike riding may be undesirable and uncomfortable.

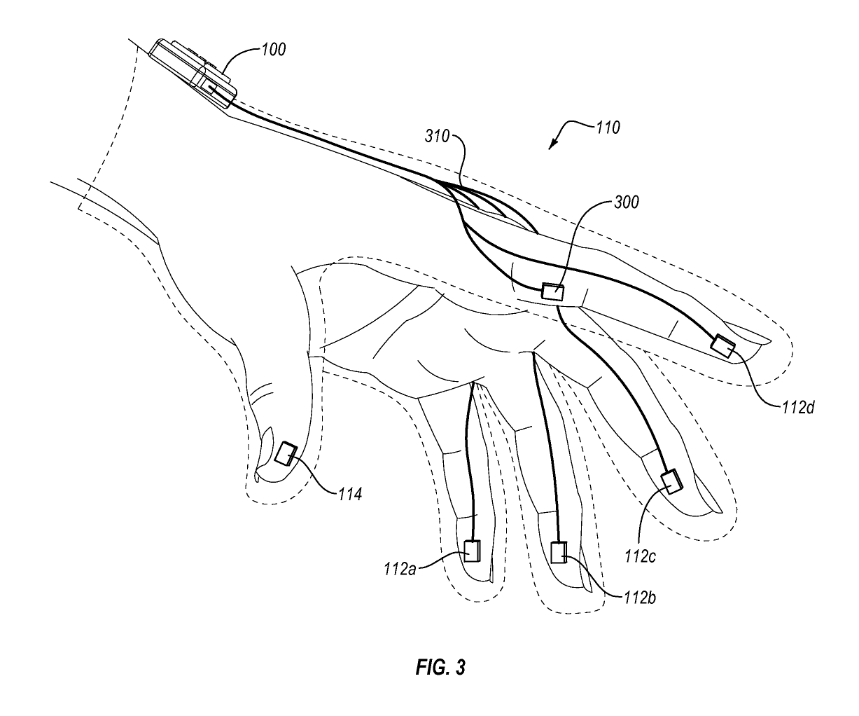

FIG. 3 depicts an implementation of the control module 100 within a glove 110. In this particular depiction, the outer surface of the glove 110 is not depicted such that the embedded sensors 112(a-e), 114 and wired connections 310 are more easily visible. FIG. 3 also depicts an additional embedded sensor 300 position at the base of the index finger. Accordingly, a user can execute a command by bringing the embedded sensor 114 within proximity to embedded sensor 300.

In at least one implementation, the wire connectors 310 comprise water-resistant and/or waterproof casings and leads that connect to the embedded sensors 112(a-d), 114, 300. In particular the wire connections 310 may be configured to be at least partially water resistant such that the glove can be used in snow sports. For example, the wire connectors 310 can comprise 30 gauge stranded copper wire placed within tubes filled with epoxy.

Additionally, the placement of the wire connectors 310 as shown can provide significant benefits to the glove 110. In particular, the placement of the wire connectors can alleviate stress points on the wires such that the wires are less likely to fail. Additionally, in at least one implementation, the wire connectors 310 are not sewn into the fabric but are instead allowed to float and move with a user's movements. Allowing the wire connectors 310 to freely move was found in some cases to significantly extend the life of the wire connectors 310.

While depicted as a single layer in FIG. 3, in at least one implementation, the glove 110 can comprise multiple layers. For example, the glove can comprise three-layers: an inner sheath enclosing the hand, a middle layer that carries the wire connectors 310, and an outer, weather-resistant layer. The control module 100 may be placed in a pouch between the outer layer and the middle layer.

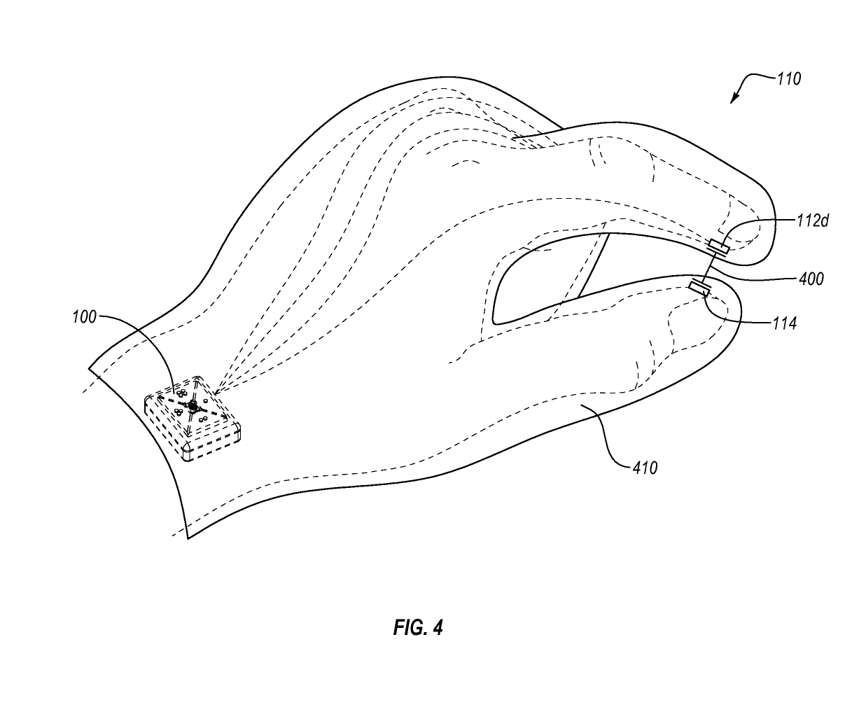

FIG. 4 depicts a glove 110, a control module 100, and two embedded sensors 112D and 114. Within the depicted glove, the outline of a user hand 410 is indicated. In various implementations, the thickness of the glove 110 may vary based on specific models. Additionally, in at least one implementation, the glove 110 may comprise a formfitting design such that the thin formfitting glove 112 can be fit within a thicker warm winter gloves. As such, implementations of the glove 110 may be provided in various form factors to meet the warmth and thickness desires of a variety of different users.

In any case, however, one will understand within particularly thick gloves it may not be possible to bring embedded sensor 112D into direct contact with embedded sensor 114. Specifically, the thickness of the glove 110 itself may prevent such direct contact. Accordingly, in at least one of mentation, embedded sensor 114 comprises a magnet of sufficient strength that it can activate a electromagnetic sensor embedded within sensor 112D. Specifically, the magnet 114 can comprise sufficient strength to activate the electromagnetic sensor 112D without requiring direct contact.

For example, in at least one implementation, the magnet 114 can activate the electromagnetic sensor 112D at distances 400 greater than 1 cm. Similarly, in at least one implementation, the magnet 114 can activate the sensors 112D at distances greater than 2 cm, 3 cm, 4 cm, or 5 cm. Accordingly, in at least one implementation, the glove 110 can still be functional even if the user is wearing a particularly thick outer glove.

In various implementations of the present invention, a user can control a mobile computing device 120 using pre-determined finger motions andor through buttons on a control module 100. Additionally, in at least one implementation, the same control module 100 that receives commands through a glove 110 can also independently communicate with and send commands to the mobile computing device 120.

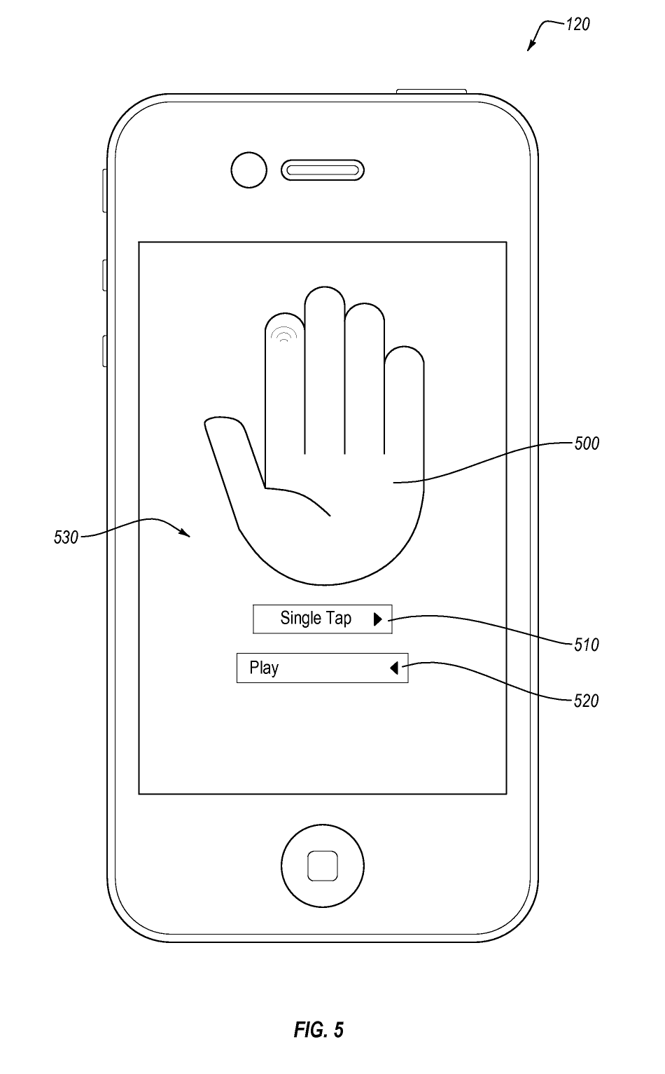

FIG. 5 depicts an implementation of a mobile computing device 120 comprising a control module interface application 530. The control module interface application 530 comprises a representation of a hand or glove 500, an indication of an action 510, and an indication of a command 520. In at least one implementation, the representation of the hand or glove 500 indicates which finger is involved in a particular command. Similarly, the action indication 510 indicates what action is involved in the command.

For example, in at least one implementation, a visual indicator may appear on the index finger of the hand or glove 500 indicating that the index finger is involved in the command. Additionally, action indicator 510 may indicate that a double tap of the index finger activates a particular command. Further, the command indication 520 can indicate the specific command that is issued to the mobile computing device 120. For example, the command may comprise play, volume up, volume down, skip, answer phone call, activate voice assistant, send text, read text, or any other of a number of mobile computing device commands.

In at least one implementation, command indication 520 may comprise commands relating to both finger motions and control module buttons. For example, a user interface similar to that depicted in FIG. 5 may also be depicted for the buttons 200. Instead of the indication of a hand or glove 500, the user interface 530 may indicate the arrangement of the buttons 200. Using methods described above, as indicated in FIG. 5, a user may select a particular button, a particular action, any particular commands associated with the button and action.

In contrast, in at least one implementation, specific buttons are statically associated with specific finger sensors. As such, when programming a particular finger, the control module interface application 530 automatically associates those actions and commands with the respective button. For instance, embedded sensor 112d may be statically associated with button 210d. As such, actions and commands associated with the index finger may automatically be associated with button 210d.

In at least one implementation, the commands can comprise commands directed towards external electronic devices 130. For example, the external electronic device 130 may comprise the digital camera. In at least one implementation, the command indicator 520 may comprise a command to take a picture or start and stop a video with a digital camera. As such, when a user performs the prescribed action (e.g, double tapping his thumb to his index finger or double pressing button 210d) the digital camera 130 can be commanded to take a picture. In at least one implementation, the command can be issued directly by the control module 100 to the camera 130. In contrast, in at least one implementation, the control module 100 communicates the command to the mobile computing device 110, which in turn, communicates the command to the camera 130.

A wide variety of different commands for external electronic devices 130 can be added to the control module user interface 530. For example, a user can download groups of specific commands for a specific electronic device to their mobile computing device 120. For instance, a user may have a particular brand of camera. The camera maker may provide specific commands to interact with the control module interface application 530. As such, the user can access the commands through download or physical media and install them within the control module interface application 300 on their mobile computing device 120.

Additionally, in at least one implementation, the external electronic device 130 must be paired or otherwise associated with the mobile computing device 120. One will understand that pairing can take place through standard Bluetooth processes, connection to an ad hoc Wi-Fi network, or some other wireless or wired communication between the mobile computing device and external electronic device. Once the external electronic device 130 is connected to the mobile computing device 120, the mobile computing device 120 may search online databases for commands and drivers necessary to communicate commands to the external electronic device 130.

Accordingly, in at least one implementation, a user can customize various fingers and finger motions to correspond with custom commands. Further, the user can later revise the commands to meet a specific interest. For example, a user may have a first set of desired command settings for skiing and a second set of desired command settings for biking.

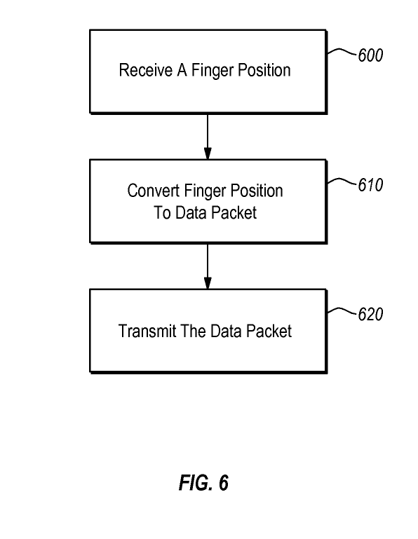

Accordingly, FIGS. 1-5 and the corresponding text illustrate or otherwise describe one or more methods, systems, andor instructions stored on a storage medium for capturing finger motions and interpreting the captured finger motions into commands for a mobile computing device. One will appreciate that implementations of the present invention can also be described in terms of methods comprising one or more acts for accomplishing a particular result. For example, FIG. 6 and the corresponding text illustrates a flowchart of a sequence of acts in a method for capturing finger motions and interpreting the captured finger motions into commands for a mobile computing device. The acts of FIG. 6 are described below with reference to the components and modules illustrated in FIGS. 1-5.

For example, FIG. 6 illustrates that a flow chart for an implementation of a method capturing finger motions and interpreting the captured finger motions into commands for a mobile computing device can comprise an act 600 of receiving a finger position. Act 600 includes receiving, from a first finger mounted sensor, a first sensed finger position of a first finger relative to a second finger. For example, in FIG. 4 and the accompanying description, embedded sensor 112d, associated with a user's index finger, is detected as being nearby embedded sensor 114, associated with a user's thumb.

Additionally, FIG. 6 illustrates that the method can comprise an act 610 of converting a finger position to a data packet. Act 610 can include converting, with a processing unit, the first sensed finger position to a data packet communicable to the mobile computing device. For example, FIG. 1 depicts the control module 100 communicating received sensor readings to the mobile computing device 120. As disclosed, the communication can comprise wired or wireless communication. In at least one implementation, converting the sensed data to a data packet may comprise preparing the data for communication over a particular protocol (e.g., Bluetooth, WiFi, Serial, etc.).

FIG. 6 also illustrates that the method can comprise an act 620 of transmitting the data packet. Act 620 can include transmitting the data packet to the mobile computing device 120, wherein the data packet causes the mobile computing device to execute a command For example, FIG. 5 depicts a control module user interface 530 that allows a user to assign specific sensor reading to actions performable by the mobile computing device 120 or some other external electronic device 130.

In various additional implementations, the control module 100 andor the mobile computing device 120 can be in communication with various cloud services. For example, in at least one implementation, a particular command may direct the control module 100 or the mobile computing device 120 to issue a command to cloud service. The command may be issued through a cellular connection, a WiFi connection, or some other wide ware network connection.

Accordingly, implementations of the present invention provide significant benefits in the field of user control of mobile computing device. In particular, implementations of the present invention provide novel methods of detecting user finger positions and translating those finger positions into commands. Further, implementations of the present invention provide a control module 100 that can both receive sensor readings relating to finger position and direct user interaction through physical interfaces.

Although the subject matter has been described in language specific to structural features andor methodological acts, it is to be understood that the subject matter defined in the appended claims is not necessarily limited to the described features or acts described above, or the order of the acts described above. Rather, the described features and acts are disclosed as example forms of implementing the claims.

Embodiments of the present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions andor data structures. Such computer-readable media can be any available media that can be accessed by a general-purpose or special-purpose computer system. Computer-readable media that store computer-executable instructions andor data structures are computer storage media. Computer-readable media that carry computer-executable instructions andor data structures are transmission media. Thus, by way of example, and not limitation, embodiments of the invention can comprise at least two distinctly different kinds of computer-readable media: computer storage media and transmission media.

Computer storage media are physical storage media that store computer-executable instructions andor data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network andor data links which can be used to carry program code in the form of computer-executable instructions or data structures, and which can be accessed by a general-purpose or special-purpose computer system. A “network” is defined as one or more data links that enable the transport of electronic data between computer systems andor modules andor other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM andor to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud-computing environment. Cloud computing environments may be distributed, although this is not required. When distributed, cloud computing environments may be distributed internationally within an organization andor have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

Some embodiments, such as a cloud-computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A method for capturing finger motions and interpreting the captured finger motions into commands for a mobile computing device, the method comprising:
receiving, from a first finger mounted sensor, a first sensed finger position of a first finger relative to a second finger;
converting, with a processing unit, the first sensed finger position to a data packet communicable to the mobile computing device; and
transmitting the data packet to the mobile computing device, wherein the data packet causes the mobile computing device to execute a command.

2. The method as recited in claim 1, further comprising receiving from a user a customized assignment of a particular sensor reading to a particular mobile computing device command.

3. The method as recited in claim 1, further comprising:
receiving, from a third finger mounted sensor, a second sensed finger position of a third finger relative to the second finger;
converting, with a processing unit, the second sensed finger position to a different data packet communicable to the mobile computing device; and
transmitting the different data packet to the mobile computing device, wherein the different data packet causes the mobile computing device to execute a different command.

4. The method as recited in claim 1, wherein the second finger comprises a thumb.

5. The method as recited in claim 1, wherein the processing unit comprises a control module and is physically distinct from the mobile computing device.

6. The method as recited in claim 5, wherein sensor module is in wired communication with the first finger mounted sensor and in wireless communication with the mobile computing device.

7. A motion capture command system for capturing finger motions directed towards controlling a mobile computer device, the system comprising:
a form fitting glove comprising at least one enclosed finger sheath;
the finger sheath comprising an embedded finger sensor unit;
a second sensor unit embedded within another portion of the form fitting glove; and
a processing unit in communication with at least one of the second sensor unit or the embedded finger sensor unit, wherein the processing unit is configured to detect a relative position of the embedded finger sensor unit with respect to the second sensor unit.

8. The system as recited in claim 7, wherein the second sensor unit comprises a magnet embedded within a thumb sheath of the glove.

9. The system as recited in claim 7, wherein the embedded finger sensor unit comprises a magnetic or electromagnetic sensor.

10. The system as recited in claim 7, wherein the embedded finger sensor unit can detect a position of the second sensor unit when the respective sensor units are more than 1 cm apart.

11. The system as recited in claim 7, wherein the processing unit is in wired communication with the embedded finger sensor unit and in wireless communication with the mobile computing device.

12. The system as recited in claim 11, wherein the mobile computing device maps the detected relative position of the embedded finger sensor unit to a particular command.

13. The system as recited in claim 12, wherein the particular command is configured to interact with a different physically separate device.

14. The system as recited in claim 13, wherein the mobile computing device communicates the particular command to the different physically separate device.

15. A device control module for receiving detected finger motions and providing commands to a mobile computing device, the device control module comprising:
a sensor input port that is configured to communicate with one or more sensors that are disposed within a glove, wherein the sensor input port comprises a connector that can be connected to and disconnected from the one or more sensors; and
at least one button positioned on a face of the device control module, wherein the button is configured to be actuated by a user;
wherein the device control module is configured to communicate one or more commands to the mobile computing device.

16. The control module as recited in claim 15, wherein the one or more sensors comprise one or more magnetic sensors.

17. The control module as recited in claim 15, wherein the device control module is configured to receive commands from both the sensor input port and the at least one button.

18. The control module as recited in claim 15, wherein the control module is configured to be attached to a glove.

19. The control module as recited in claim 15, wherein the sensor input port is configured to communicate with a specific number of sensors and the device control module comprises the same number of buttons as the specific number of sensors.

20. The control module as recited in claim 15, wherein the device control module is configured to communicate one or more commands to the mobile computing device when the connector is disconnected from the one or more sensors.
